(19) United States
(12) Patent Application Publication
(10) Pub. No.: US 2019/0375233 A1
(43) Pub. Date: Dec. 12, 2019

(54) METHOD AND APPARATUS TO ADAPT A REAR SUSPENSION

(71) Applicant: Pindz Mooker-Mahadev, Richmond (CA)

(72) Inventor: Pindz Mooker-Mahadev, Richmond (CA)

(21) Appl. No.: 16/003,667

(22) Filed: Jun. 8, 2018

(51) Int. Cl. B60B 3/14; B62D 65/12; B60G 21/05

(52) U.S. Cl. CPC B60B 3/147; B60B 2900/351; B60G 21/051; B62D 65/12

(57) ABSTRACT

A method and apparatus for adapting a vehicle rear suspension wherein the apparatus comprises a substantially circular plate having first and second surfaces with a central bore therethrough and with closed and open notches extending into a circumferential edge thereof, a pair of outer mounting bores extending through the plate proximate to the circumferential edge with the closed notch therebetween and a plurality of first and second inner mounting bores distributed around the central bore. The method comprises removing a multi-link rear suspension assembly from the vehicle and removing left and right wheel assemblies from the multi-link rear suspension assembly mounting an adaptor plate to each of the left and right wheel assemblies on an inside surface thereof with a first set of fasteners, mounting an axle beam of a torsion bar rear suspension assembly to each of the adaptor plates with a second set of fasteners and securing the torsion bar rear suspension assembly to the vehicle.

### BACKGROUND OF THE INVENTION

### 1. Field of Invention

The present invention relates generally to rear suspensions on vehicles and in particular to a method and apparatus to adapt a vehicle to replace an OEM independent multi-link rear suspension with a torsion beam rear suspension.

### 2. Description of Related Art

Passenger vehicles may be built with one of several types of rear suspension systems. When an independent multi-link rear suspension is used, a portion of the vehicle's interior volume is occupied by coil springs. A torsion beam rear suspension has a small profile along the width of the vehicle, takes up less of the interior volume, and the ride height can be easily adjusted.

In some cases, it is desirable to convert a standard passenger vehicle, such as a minivan, to include a rear entry wheelchair lift. With an independent rear suspension vehicle, it is difficult to accommodate the ramp system within the vehicle while providing sufficient space for both the ramp and a wheelchair within the interior of the vehicle.

### SUMMARY OF THE INVENTION

According to a first embodiment of the present invention there is disclosed a method for adapting a vehicle rear suspension comprising removing a multi-link rear suspension assembly from the vehicle and removing left and right wheel assemblies from the multi-link rear suspension assembly. The method further comprises mounting an adaptor plate to each of the left and right wheel assemblies on an inside surface thereof with a first set of fasteners, mounting an axle beam of a torsion bar rear suspension assembly to each of the adaptor plates with a second set of fasteners and securing the torsion bar rear suspension assembly to the vehicle.

According to a further embodiment of the present invention there is disclosed an adaptor plate for adapting a torsion bar rear suspension assembly to a wheel assembly comprising a substantially circular plate having first and second surfaces with a central bore therethrough and with closed and open notches extending into a circumferential edge thereof, a pair of outer mounting bores extending through the plate proximate to the circumferential edge with the closed notch therebetween and a plurality of first and second inner mounting bores distributed around the central bore.

The central bore may include a cylindrical raised lip therearound extending from the first surface. The cylindrical raised lip may be adapted to correspond to and be receivable within a central mounting bore in a rear axle beam of the torsion bar rear suspension assembly. The central bore may include an enlarged portion extending into the second surface adapted to receive a portion of the wheel assembly therein.

The closed notch may be sized to receive a disc brake caliper assembly therein. The pair of outer mounting bores may be sized and positioned to correspond to a pair of mounting holes on a disc brake caliper mounting bracket. The open notch may be sized to receive a parking brake clip on the wheel assembly to pass therethrough.

The plurality of first mounting bores may be located at positions selected to correspond to a plurality of mounting holes on the wheel assembly. Each of the plurality of first mounting bores may include an enlarged opening extending into the first surface. The plurality of second mounting holes may include internal threading. The plurality of second mounting holes may be located at positions selected to correspond to a plurality of mounting holes on the torsion bar rear suspension assembly. The plurality of second mounting holes may be blind holes extending into the first surface.

The first surface may include a substantially circular first raised surface at a central portion thereof. The second surface may include a substantially circular second raised surface at a central portion thereof.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of torsion bar rear suspension assembly mounted with adaptor plates to wheel assemblies for a multi-link rear suspension vehicle according to a first embodiment of the invention.

FIG. 2 is an exploded perspective partial view of the apparatus of FIG. 1.

FIG. 3 is an inside perspective view of the adaptor plate of FIG. 1.

FIG. 4 is an outside perspective view of the adaptor plate of FIG. 1.

FIG. 5A is an inside plan view of a left side adaptor plate.

FIG. 5B is an inside plan view of a right side adaptor plate.

FIG. 6A is an outside plan view of a left side adaptor plate

FIG. 6B is an outside plan view of a right side adaptor plate.

FIG. 7 is an inside plan view of an adaptor plate mounted to the rotor assembly.

FIG. 8 is an inside partial cross-sectional view of the mounting portion of a torsion bar rear suspension assembly mounted to an adaptor plate.

### DETAILED DESCRIPTION

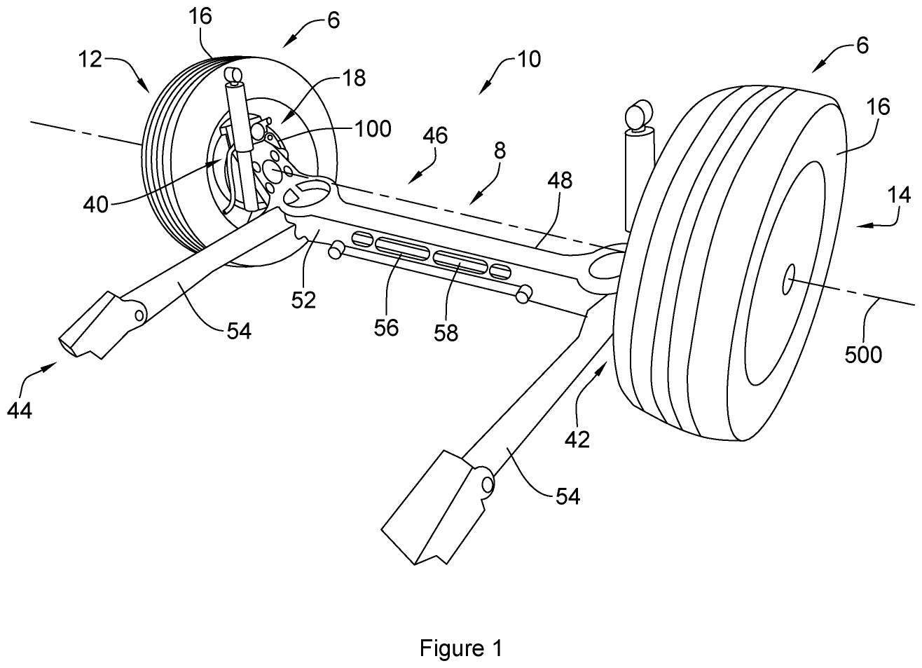

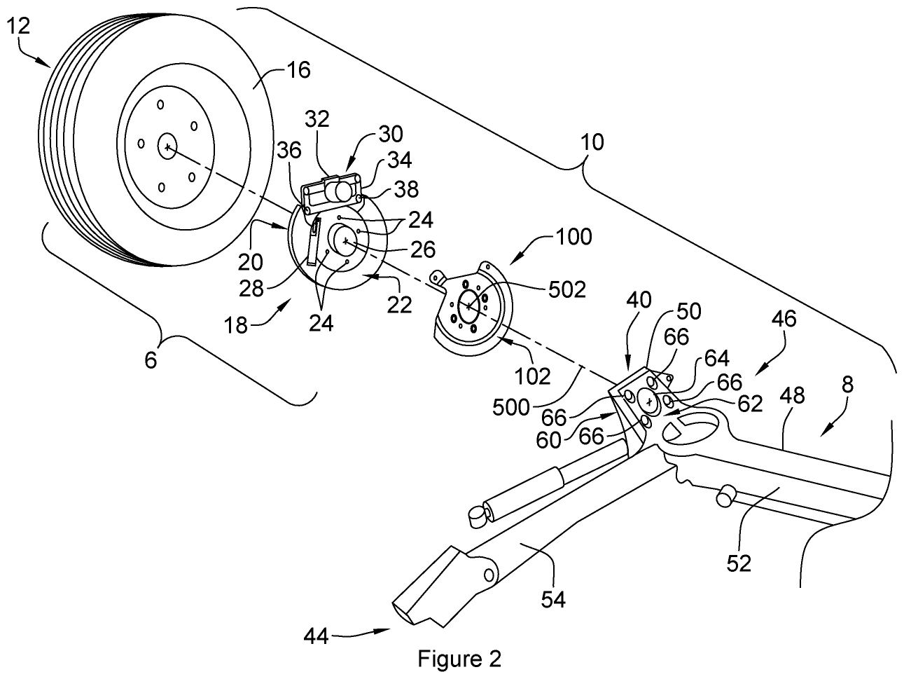

Referring to FIGS. 1 and 2, a torsion bar rear suspension assembly adapted for use in a multi-link independent rear suspension vehicle according to the first embodiment of the invention is shown generally at 10. The adapted assembly 10 includes two adaptor plates 100 mounted to wheel assemblies 6 for a multi-link rear suspension vehicle, with a torsion bar rear suspension assembly 8 mounted therebetween, as will be further set out below.

Referring now to FIGS. 1 and 2, the adapted assembly 10 extends between right and left vehicle sides, 12 and 14, respectively, and includes a wheel assembly 6 on each vehicle side, 12 and 14. As is commonly known, right and left side parts of a vehicle are formed as mirror images, and for the purpose of this description, only the right vehicle side 12 will be described in detail.

Referring to FIG. 2, the wheel assembly 6 is comprised of a wheel 16 with a central rotation axis 500 mounted to a rotor assembly 18, by means as are commonly known. The substantially circular rotor assembly 18 extends between outside and inside surfaces, 20 and 22, respectively, and includes a plurality of threaded mounting bores 24 distributed around the central rotation axis 500 and extending into the inside surface 22, as is commonly known. As illustrated in FIG. 2, the rotor assembly 18 may include four mounting bores 24, although it will be appreciated that more or less mounting bores 24 may be included dependent on the OEM manufacturer of the rotor assembly 18. The inside surface 22 of the rotor assembly 18 includes a central raised circular portion 26 extending therefrom.

The rotor assembly 18 includes a disc brake assembly 30 with a brake caliper 32 mounted on a caliper bracket 34. The caliper bracket 34 includes front and rear lower mounting holes, 36 and 38, respectively, as illustrated in FIG. 2. A parking brake clip 28 is mounted to the inside surface 22 of the rotor assembly 18. A parking brake cable (not shown) extends from the disc brake assembly 30 and is secured to the parking brake clip 28 during operation, as is commonly known.

The torsion bar rear suspension assembly 8 extends between right and left sides, 40 and 42, respectively, and between front and rear, 44 and 46, respectively, as indicated in FIG. 1. As previously noted, only the right side 40 will be explained in detail. The torsion bar rear suspension assembly 8 includes an axle beam 48, extending between the right and left sides, 40 and 42. The axle beam 48 includes a mounting portion 50 at each side, 40 and 42, proximate to the rear 46 with an elongate crossbar portion 52 extending therebetween, and two elongate arm portions 54 proximate to each of the right and left sides, 40 and 42, extending perpendicularly from the crossbar portion 52 to proximate the front 44. The crossbar portion 52 may be formed with a cavity 56 therein. An elongate support bar 58 extending substantially between the right and left sides, 40 and 42, may be installed within the cavity 56 by known means, such as, by way of non-limiting example, welding, to increase the strength of the crossbar portion 52.

The mounting portion 50 includes outer and inner surfaces, 60 and 62, respectively, with a central bore 64 extending therethrough, which is aligned on the central rotation axis 500 when installed. A plurality of axle beam mounting bores 66 are distributed around the central bore 64, extending between the outer and inner surfaces, 60 and 62. As illustrated in FIG. 2, the mounting portion 50 may include four axle beam mounting bores 66, although it will be appreciated that more or less axle beam mounting bores 66 may be included dependent on the OEM manufacturer of the torsion bar rear suspension assembly 8.

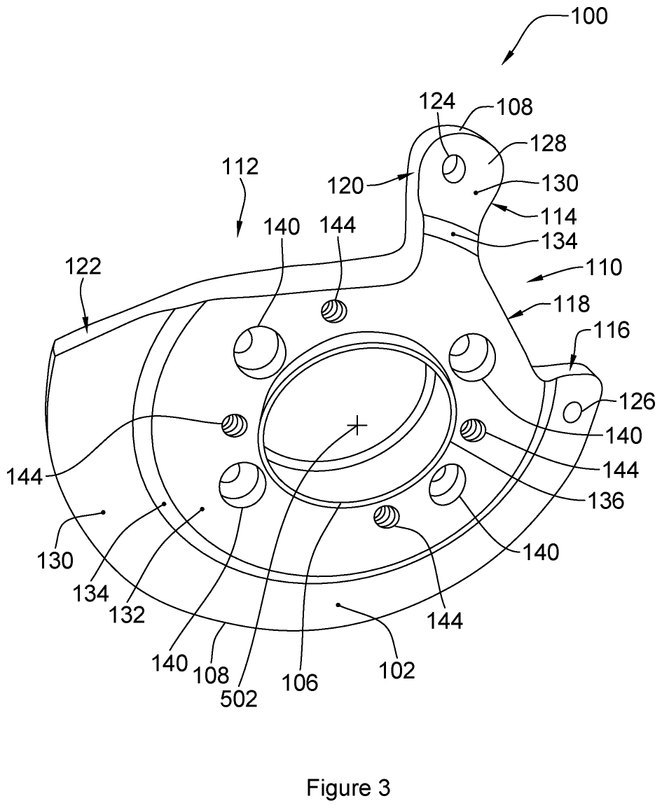

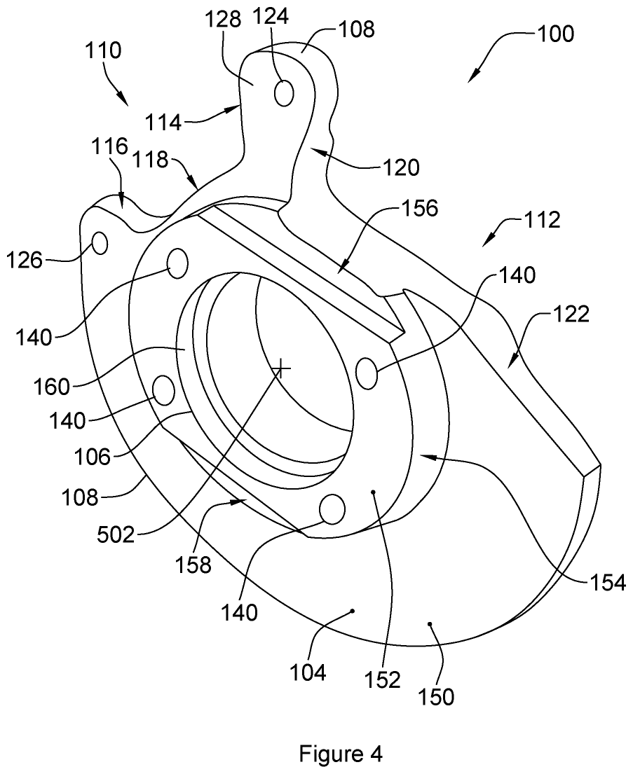

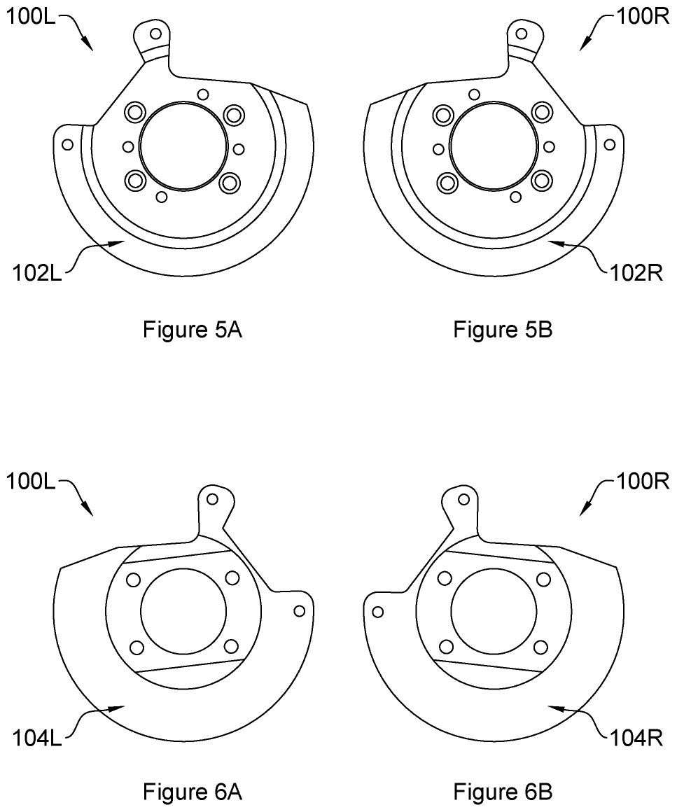

Turning now to FIGS. 2 through 5, the substantially circular adaptor plate 100 includes an inside surface 102, as best illustrated in FIG. 3, and an outside surface 104, as best illustrated in FIG. 4. As previously noted, it is commonly known that vehicle parts are mirrored on the left and right sides. FIGS. 5A and 5B illustrate the left and right inside surfaces, 102L and 102R, respectively, for the left and right adaptor plates, 100L and 100R, respectively while FIGS. 6A and 6B illustrate the left and right outside surfaces, 104L and 104R, respectively, for the left and right adaptor plates 100L and 100R. All further details will be set out for the right adaptor plate 100R only, with the understanding that the left adaptor plate 100L has mirrored parts.

Referring to FIG. 3, the adaptor plate 100 is substantially circular and extends between a central axis 502 and a circumferential edge 108 with closed and open notches, 110 and 112, therein. The closed notch 110 extends between first and second closed notch radial edges, 114 and 116, respectively, with an inner closed notch edge 118 extending therebetween. The open notch 112 extends between an open notch radial edge 120 and an open notch bottom edge 122 which extends to the circumferential edge 108.

The adaptor plate 100 includes a mounting portion 128 extending to the circumferential edge 108 between the first closed notch radial edge 114 of the closed notch 110 and the open notch radial edge 120 of the open notch 112. The mounting portion 128 includes a brake front caliper mounting hole 124 extending therethrough proximate to the circumferential edge 108. A brake rear caliper mounting hole 126 extends through the adaptor plate 100 proximate to the second closed notch radial edge 116 and proximate to the circumferential edge 108. The size and relative position of the brake front and rear caliper mounting holes, 124 and 126, are selected to correspond to the front and rear lower mounting holes, 36 and 38, on the caliper bracket 34 when the adaptor plate 100 is mounted to the rotor assembly 18 with the central axis 502 aligned with the central rotation axis 500. The size and shape of the closed notch 110 is selected to allow a portion of the brake caliper 32 to pass therethrough. The size and shape of the open notch 112 is selected to allow the parking brake clip 28 to pass therethrough.

The inside surface 102 includes a peripheral portion 130 extending therearound from the circumferential edge 108 and a central raised portion 132, with a sloped surface 134 therebetween. A central bore 106 extends through the central raised portion 132, between the inside and outside surfaces, 102 and 104. A cylindrical raised lip 136 extends from the central raised portion 132 around the exterior of the central bore 106. The raised lip 136 is selected to correspond to the central bore 64 on the mounting portion 50 of the axle beam 48 such that it may be received therein.

A plurality of recessed wheel assembly mounting bores 140 extend through the central raised portion 132 between the inside and outside surfaces, 102 and 104, distributed around the central bore 106. The wheel assembly mounting bores 140 are sized and positioned to correspond to the mounting bores 24 on the rotor assembly 18 of the wheel assembly 6. As set out above, the present embodiment of the invention is illustrated with four wheel assembly mounting bores 140, although it will be appreciated that more or less wheel assembly mounting bores 140 may be used to correspond to the mounting bores 24 on the rotor assembly 18. Each wheel assembly mounting bore 140 may include an enlarged opening extending into the adaptor plate 100 from the inside surface 102 to allow for the head of a fastener (not shown) to be retained therein, as is commonly known with recessed mounting holes.

A plurality of threaded rear suspension assembly mounting bores 144 extend into the central raised portion 132 from the inside surface 102, distributed around the central bore 106. The rear suspension assembly mounting bores 144 are sized and positioned to correspond to the axle beam mounting bores 66 on the axle beam 48 of the torsion bar rear suspension assembly 8. As set out above, the present embodiment of the invention is illustrated with four rear suspension assembly mounting bores 144, although it will be appreciated that more or less rear suspension assembly mounting bores 144 may be used to correspond to the axle beam mounting bores 66 on the axle beam 48.

Turning now to FIG. 4, the outside surface 104 includes a peripheral portion 150 extending therearound from the circumferential edge 108 and a central raised portion 152, with an annular wall 154 therebetween. The central raised portion 152 may include intermediate upper and lower chamfered portions 156 and 158. The size of the annular wall 154 between the peripheral portion 150 and the central raised portion 152 is selected such that, when mounted, the peripheral portion 150 engages upon the caliper bracket 34 and the central raised portion 152 engages upon the inside surface 22 of the rotor assembly 18.

The wheel assembly mounting bores 140 extend through the outside surface 104, as set out above. The central bore 106 includes an enlarged portion 160 extending into the outside surface 104 selected to receive the central raised circular portion 26 on the rotor assembly 18 therein.

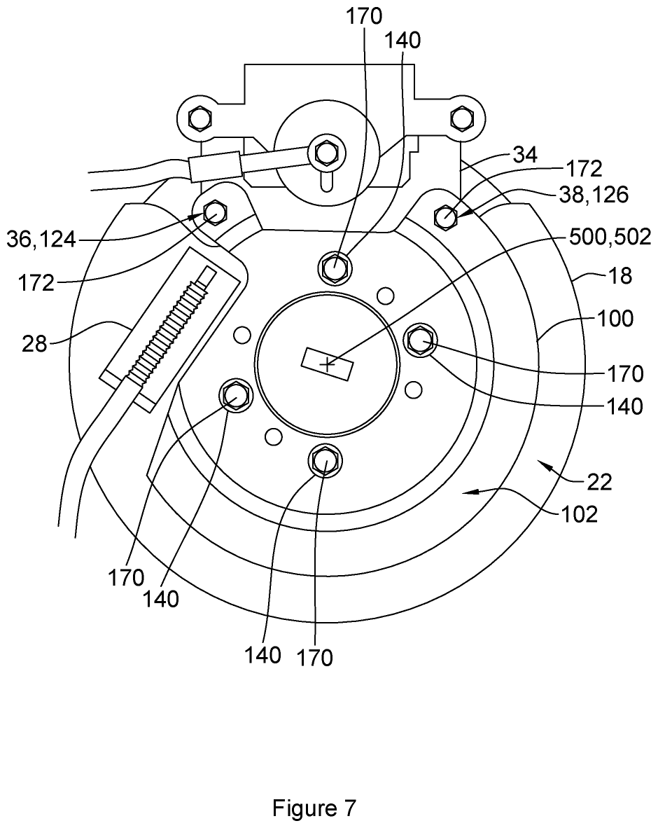

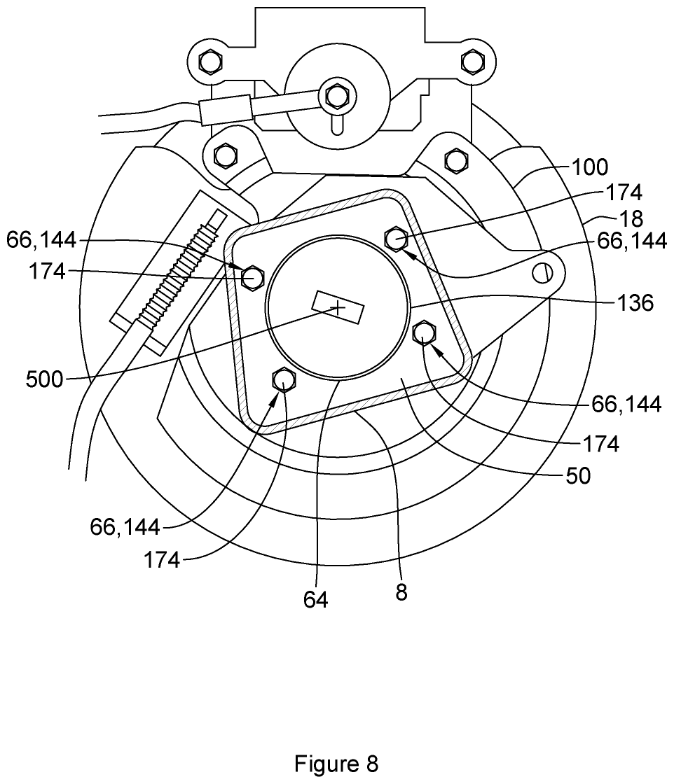

Referring now to FIGS. 2 and 7, to install the adaptor plate 100, the adaptor plate 100 is positioned with the outside surface 104 engaged upon the inside surface 22 of the rotor assembly 18. The adaptor plate 100 is positioned in engagement with the rotor assembly 18 such that the central axis 502 is aligned with the central rotation axis 500 of the wheel assembly 6, and the brake front and rear caliper mounting holes, 124 and 126, are positioned in alignment with the front and rear lower mounting holes, 36 and 38, on the caliper bracket 34. A set of threaded wheel assembly fasteners 170 are passed through the recessed wheel assembly mounting bores 140 from the inside surface 102 and secured into the threaded mounting bores 24 in the rotor assembly 18 with the heads of the wheel assembly fasteners located such that they do not protrude above the inside surface 102 of the adaptor plate 100. A pair of brake caliper bracket mounting fasteners 172 are passed through the brake front and rear caliper mounting holes, 124 and 126, and secured within the front and rear lower mounting holes, 36 and 38, in the caliper bracket 34.

Referring now to FIGS. 2 and 8, with the adaptor plate 100 secured to the rotor assembly 18, the adaptor plate 100 is then positioned with the inside surface 102 engaged upon the outer surface 60 of the mounting portion 50 on the torsion bar rear suspension assembly 8. The raised lip 136 engages within the central bore 64, thereby aiding to align the axle beam mounting bores 66 with the rear suspension assembly mounting bores 144. A set of threaded rear suspension assembly fasteners 174 is passed through the axle beam mounting bores 66 and engaged within the threaded rear suspension assembly mounting bores 144, securing the torsion bar rear suspension assembly 8 to the mounting plate 100 and thereby to the wheel assembly 6. This process is repeated on the left side of the vehicle, as is commonly known. Following assembly, the adapted assembly 10 is secured to a vehicle, as is commonly known in the art.

While specific embodiments of the invention have been described and illustrated, such embodiments should be considered illustrative of the invention only and not as limiting the invention as construed in accordance with the accompanying claims.

What is claimed is:

1. A method for adapting a vehicle rear suspension comprising:
removing a multi-link rear suspension assembly from the vehicle;
removing left and right wheel assemblies from said multi-link rear suspension assembly;
mounting an adaptor plate to each of said left and right wheel assemblies on an inside surface thereof with a first set of fasteners;
mounting an axle beam of a torsion bar rear suspension assembly to each of said adaptor plates with a second set of fasteners;
securing said torsion bar rear suspension assembly to said vehicle.

2. An adaptor plate for adapting a torsion bar rear suspension assembly to a wheel assembly comprising:
a substantially circular plate having first and second surfaces with a central bore therethrough and with closed and open notches extending into a circumferential edge thereof;
a pair of outer mounting bores extending through said plate proximate to said circumferential edge with said closed notch therebetween; and
a plurality of first and second inner mounting bores distributed around said central bore.

3. The adaptor plate of claim 2 wherein said central bore includes a cylindrical raised lip therearound extending from said first surface.

4. The adaptor plate of claim 3 wherein said cylindrical raised lip is adapted to correspond to and be receivable within a central mounting bore in a rear axle beam of the torsion bar rear suspension assembly.

5. The adaptor plate of claim 2 wherein said central bore includes an enlarged portion extending into said second surface adapted to receive a portion of the wheel assembly therein.

6. The adaptor plate of claim 2 wherein said closed notch is sized to receive a disc brake caliper assembly therein.

7. The adaptor plate of claim 6 wherein said pair of outer mounting bores are sized and positioned to correspond to a pair of mounting holes on a disc brake caliper mounting bracket.

8. The adaptor plate of claim 2 wherein said open notch is sized to receive a parking brake clip on the wheel assembly to pass therethrough.

9. The adaptor plate of claim 2 wherein said plurality of first mounting bores are located at positions selected to correspond to a plurality of mounting holes on the wheel assembly.

10. The adaptor plate of claim 9 wherein each of said plurality of first mounting bores includes an enlarged opening extending into said first surface.

11. The adaptor plate of claim 2 wherein said plurality of second mounting holes include internal threading.

12. The adaptor plate of claim 11 wherein said plurality of second mounting holes are located at positions selected to correspond to a plurality of mounting holes on the torsion bar rear suspension assembly.

13. The adaptor plate of claim 12 wherein said plurality of second mounting holes are blind holes extending into said first surface.

14. The adaptor plate of claim 2 wherein said first surface includes a substantially circular first raised surface at a central portion thereof.

15. The adaptor plate of claim 2 wherein said second surface includes a substantially circular second raised surface at a central portion thereof.
